(19) United States
(12) Patent Application Publication
(10) Pub. No.: US 2016/0107620 A1
(43) Pub. Date: Apr. 21, 2016

(54) METHOD OF ASSISTING MACHINES AT WORKSITE

(71) Applicant: Caterpillar Inc., Peoria, IL (US)

(72) Inventor: James D. Humphrey, Decatur, IL (US)

(73) Assignee: Caterpillar Inc., Peoria, IL (US)

(21) Appl. No.: 14/981,983

(22) Filed: Dec. 29, 2015

(51) Int. Cl. B60T 3/00; G05D 1/00

(52) U.S. Cl. CPC B60T 3/00; G05D 1/0011

(57) ABSTRACT

A method of operating a wheel chock for assisting an autonomous machine at a worksite is provided. The method includes receiving a signal indicative of one or more operating parameters of the autonomous machine. The method further includes determining if the one or more operating parameters of the autonomous machine indicate a non-operating state of the autonomous machine. The method further includes establishing a communication between the wheel chock and the autonomous machine, if the autonomous machine is in the non-operating state. The method further includes guiding the wheel chock to be placed adjacent with respect to a set of ground engaging members of the autonomous machine to restrict movement of the autonomous machine at the worksite. The wheel chock is guided by an assisting machine. The method further includes moving the wheel chock away from the autonomous machine when the autonomous machine is in an operating state.

### TECHNICAL FIELD

The present disclosure relates to operating multiple machines, and more particularly relates to a method of assisting machines at a worksite.

### BACKGROUND

Generally, machines are equipped with emergency or parking brake systems that function to maintain the machines in a parked position. Parking brakes are placed on the wheels of the machine and prevent the movement/rotation of the wheels while the machine is parked. Autonomous machines, which are operated from a remote operating station, can be maneuvered and stopped from the remote operating station. These autonomous machines when shutdown under normal operating conditions, are directed towards a parking area in a worksite. However, whenever an autonomous machine is shutdown under abnormal operating conditions, personnel in the worksite has to immediately attend the machine and prevent it from any sort of movement.

U.S. Pat. No. 6,378,956 (the '956 patent) describes a vehicular wheel chock assembly and method of operation for use in providing automatic and positive chocking of one or more wheel of a vehicle upon setting of the vehicle's emergency/parking brakes, and automatic retraction of the chock assembly upon release of the emergency/parking brakes. Retraction and extension of air pressures are derived from the accessory air reservoir upon engagement and release, respectively, of the vehicle's air powered parking or emergency brakes. Thus, the vehicle driver has to engage the emergency/parking brakes when parking the vehicle to cause the wheel chocks to be moved from their retracted positions to their engaged positions in front of and behind vehicle wheel. In this way, the wheel chock assembly positively forces the wheel chocks into engagement with the parked vehicle wheels and the surface they rest on or positively collapses the chock assembly into a compact configuration at the underside of the vehicle on which the chock assembly is mounted. However, the '956 patent does not disclose assistance of operation between multiple machines.

### SUMMARY OF THE DISCLOSURE

In one aspect of the present disclosure, a method of operating a wheel chock for assisting an autonomous machine at a worksite is provided. The method includes receiving a signal indicative of one or more operating parameters of the autonomous machine. The method further includes determining if the one or more operating parameters of the autonomous machine indicate a non-operating state of the autonomous machine. The method further includes establishing a communication between the wheel chock and the autonomous machine, if the autonomous machine is in the non-operating state. The method further includes guiding the wheel chock to be placed adjacent with respect to ground engaging members of the autonomous machine to restrict movement of the autonomous machine at the worksite. The wheel chock is guided by an assisting machine. The method further includes moving the wheel chock away from the autonomous machine when the autonomous machine is in an operating state indicated by the one or more operating parameters of the autonomous machine.

Other features and aspects of this disclosure will be apparent from the following description and the accompanying drawings.

### BRIEF DESCRIPTION OF THE DRAWINGS

FIG. 1 is a schematic side view of an autonomous machine along with an assisting machine operating at a worksite, according to an embodiment of the present disclosure;

FIG. 2 is a schematic side view showing assisting of the autonomous machine with a wheel chock

FIG. 3 is a block diagram of a system for operating the wheel chock carried by the assisting machine for assisting the autonomous machine at the worksite; and

FIG. 4 is a flowchart of a method of operating the wheel chock for assisting the autonomous machine at the worksite.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

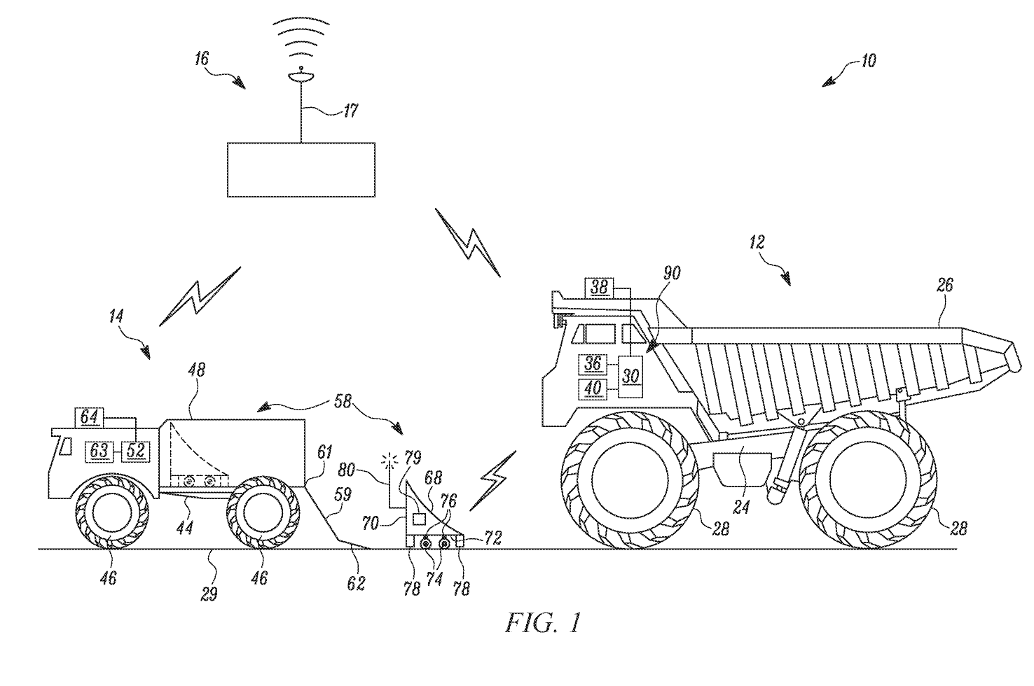

FIG. 1 illustrates a schematic side view of an autonomous machine 12 and an assisting machine 14 operating at a worksite 10. The worksite 10 may be, for example, a mine site, a landfill, a quarry, a construction site, or any other type of worksite known in the art. In the worksite 10, there may be multiple machines operating to perform various operations, such as a drilling operation, an excavating operation, a hauling operation, a dumping operation, and a grading operation. The autonomous machine 12 and the assisting machine 14 are in wireless communication with a remote station 16 at the worksite 10. The remote station 16 includes an antenna 17 configured to receive signals from the autonomous machine 12 and the assisting machine 14. In an example, the remote station 16 may include an off-board controller. The worksite 10 may include a parking area for parking the autonomous machine 12. More specifically, the autonomous machine 12 is shutdown intentionally by an operator or autonomously based on certain instructions from the remote station 16, and parked in the parking area at the worksite 10 to avoid any disruption to work flow at the worksite 10. The parking area may accommodate multiple autonomous machines 12 and multiple assisting machines 14.

In the illustrated embodiment, the autonomous machine 12 is a mining truck. However, it may be understood that the autonomous machine 12 may also include, but is not limited to, a haul truck, an articulated truck, an off-highway truck or any other autonomous machine that performs operation associated with industries such as mining, construction, farming, transportation, or any other industry known in the art. The autonomous machine 12 may be a self-directed machine, which is in communication with the remote station 16 to travel along an operating path at the worksite 10.

The autonomous machine 12 includes a frame 24 for supporting various components of the autonomous machine 12. The autonomous machine 12 further includes a payload carrier 26 supported on the frame 24. The payload carrier 26 is pivotally connected to the frame 24 for carrying a load. The payload carrier 26 can be tilted between a lowered position and a lifted position, to dump the load from the payload carrier 26. Further, the autonomous machine 12 includes a set of ground engaging members 28 for propelling the autonomous machine 12 over a ground surface 29. The autonomous machine 12 further includes a first controller 30 for facilitating autonomous control of the autonomous machine 12.

The first controller 30 is in electronic communication with a first locating device 36, a first communicating device 38, and a sensing module 40 disposed in the autonomous machine 12. The first controller 30 is further configured to be in electronic communication with the remote station 16 via the first communicating device 38. The first locating device 36 is configured to generate a signal indicative of a position of the autonomous machine 12. The first locating device 36 may include, but is not limited to, a global navigation satellite system (GNSS), glonast, galileo, an inertial measurement unit, a tracking system, a laser range finding device, an odometric or dead-reckoning device, or any other device known in the art.

The first communicating device 38 may include hardware component and/or software component that enable sending of data between the first controller 30 and the remote station 16. The first controller 30 receives instructions from the remote station 16. Based on information received from the first locating device 36 and instruction from the remote station 16, the first controller 30 regulates movement and/or operation of the autonomous machine 12.

Referring to FIG. 1, the assisting machine 14 includes a frame 44 for supporting various components of the assisting machine 14. The assisting machine 14 further includes a set of ground engaging members 46. Further, the assisting machine 14 includes a bed 48 supported on the frame 44. The assisting machine 14 further includes a second controller 52 for controlling movement of the assisting machine 14.

The bed 48 is pivotally connected to the frame 44 for carrying a wheel chock 58. In the illustrated embodiment, although one wheel chock 58 is described, the assisting machine 14 may include multiple wheel chocks 58. The bed 48 includes a ramp 59 for assisting deployment of the wheel chock 58 from the bed 48 to the ground surface 29. The ramp 59 is connected to the bed 48 of the assisting machine 14. The ramp 59 includes an upper end 61 and a lower end 62. The upper end 61 of the ramp 59 is pivotally connected to the bed 48 of the assisting machine 14. The lower end 62 is angled to a length of the ramp 59, at an angle less than 180 degrees, to provide smooth movement of the wheel chock 58 from the bed 48 to the ground surface 29. The second controller 52 of the assisting machine 14 governs opening and closing of the ramp 59 for deploying the wheel chock 58 on the ground surface 29.

The second controller 52 is in communication with a second locating device 63, a second communication device 64 and the remote station 16. The second locating device 63 generates a signal indicative of a position of the assisting machine 14 at the worksite 10. The second locating device 63 may include, but is not limited to, a global navigation satellite system (GNSS), glonast, galileo, an inertial reference unit, a local tracking system, a laser range finding device, an odometric or dead-reckoning device, or any other device known in the art. The second communicating device 64 includes hardware component and/or a software component that enable sending of data between the second control module and the remote station 16. The second controller 52 receives information from the second locating device 63 and instructions from the remote station 16. Based on information received from the second locating device 63 and instructions from the remote station 16, the second controller 52 regulates movement of the assisting machine 14.

The wheel chock 58 is deployed from the bed 48 of the assisting machine 14, based on information received by the second controller 52 from the remote station 16. The wheel chock 58 assists the autonomous machine 12 at the worksite 10, when the autonomous machine 12 is in a non-operating state. The non-operating state herein refers to a state of the autonomous machine 12 in which the autonomous machine 12 abruptly shuts down under abnormal operating conditions and becomes inoperable.

The wheel chock 58 has a wedge profile. The wheel chock 58 includes a front surface 68, a side surface 70 and a bottom surface 72. The front surface 68 has a concave profile to engage with the ground engaging members 28 of the autonomous machine 12. The front surface 68 of the wheel chock 58 remains in contact with the ground engaging members 28 to restrict movement of the autonomous machine 12, when the autonomous machine 12 is in the non-operating state.

Further, the wheel chock 58 includes multiple wheels 74 for propelling the wheel chock 58 over the ground surface 29. The wheels 74 are disposed on the bottom surface 72 of the wheel chock 58. Each of the wheels 74 of the wheel chock 58 is connected to a plurality of damping members 76. The wheel chock 58 further includes a plurality of support members 78 for supporting the wheel chock 58 on the ground surface 29. The plurality of support members 78 are disposed on a periphery (not shown) of the bottom surface 72 to support the wheel chock 58 on the ground surface 29, when the wheel chock 58 is placed adjacent with respect to the ground engaging members 28 of the autonomous machine 12. In one example, the support members 78 may be coated with rubber material to enhance grip of the wheel chock 58 on the ground surface 29. Further, the wheel chock 58 includes a third controller 79 for controlling a movement of the wheel chock 58, and an antenna 80 for enabling communication between the second controller 52 and the third controller 79.

In an example, the wheel chock 58 may be powered by an electrical power storage device that is chargeable by using a power source (not shown) of the autonomous machine 12. In another example, the electrical power storage device is chargeable by using a power source of the assisting machine 14. Further, in an example, the electrical power source may include, but is not limited to, a battery, and a super capacitor. In the illustrated embodiment, the autonomous machine 12 further includes a system 90 for operating the wheel chock 58 for assisting the autonomous machine 12 at the worksite 10. The system 90 is in electric communication with the remote station 16 and the assisting machine 12 to operate the wheel chock 58. In other embodiments, the system 90 may be disposed in the remote station 16 or the assisting machine 14.

The assisting machine 14 is an off road truck. In an example, the assisting machine 14 may include, but is not limited to, a wheeled vehicle, a go-kart, an all Terrain Vehicle, a buggy, a dumper or any load carrying vehicle known in the art. The assisting machine 14 is a self-directed machine that is in communication with the remote station 16 to travel along a path at the worksite 10.

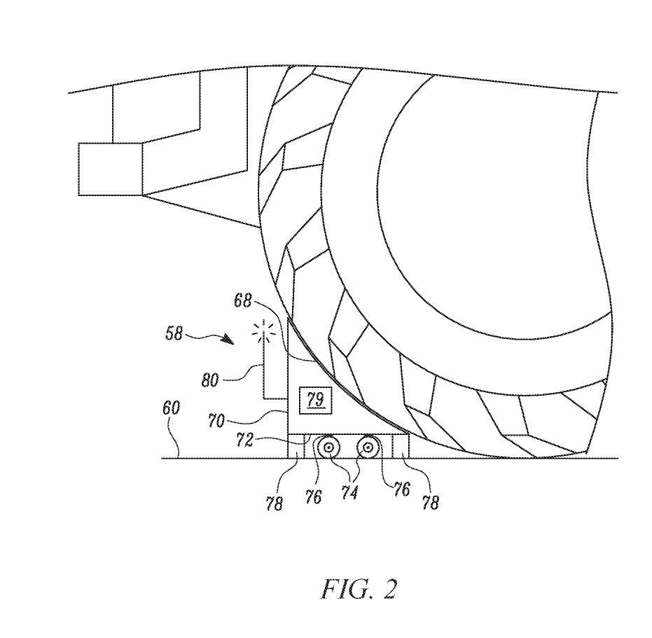

FIG. 2 illustrates a schematic side view showing the wheel chock 58 engages with the ground engaging members 28 of the autonomous machine 12. When the wheel chock 58 is placed adjacent with respect to the ground engaging members 28, the damping members 76 compresses to reduce a ground clearance of the wheel chock 58. The term “ground clearance” herein refers to a distance between the bottom surface 72 of the wheel chock 58 and the ground surface 29. Due to compression of the damping members 76, the support members 78 disposed on the periphery of the bottom surface 72 comes in contact with the ground surface 29. The support members 78 restrict the movement of the wheel chock 58 with respect to the ground surface 29 and enhances grip of the wheel chock 58 on the ground surface 29.

When the autonomous machine 12 returns to the operating state, the wheel chock 58 is moved away from the ground engaging members 28 of the autonomous machine 12. In an alternative embodiment, the autonomous machine 12 may include a carriage for carrying the wheel chock 58 that assists the autonomous machine 12 when the autonomous machine 12 is in the non-operating state. The wheel chock 58 is retrievable by the autonomous machine 12, when the autonomous machine 12 returns to the operating state.

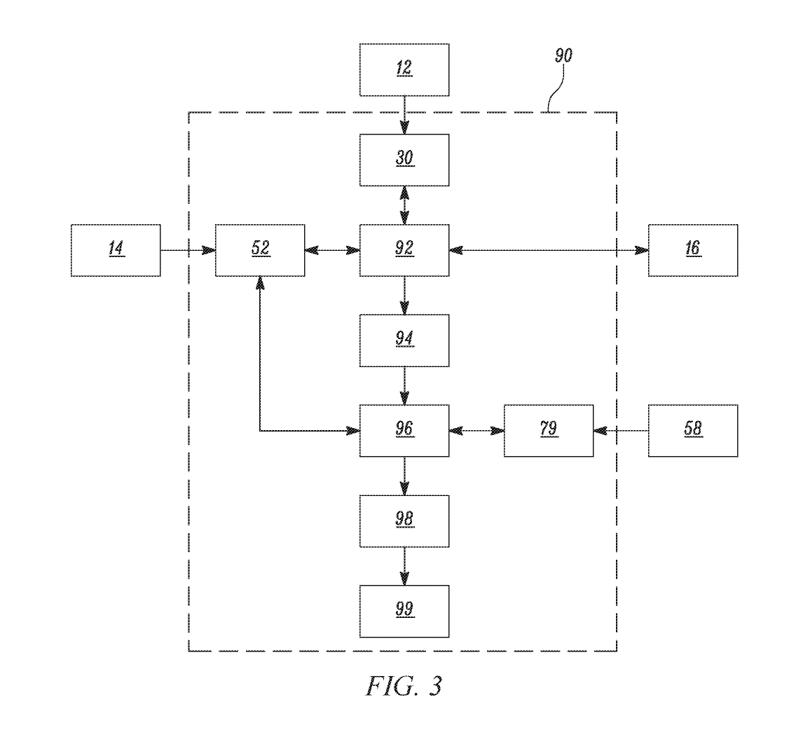

FIG. 3 illustrates a block diagram of the system 90 for operating the wheel chock 58 for assisting the autonomous machine 12 at the worksite 10. At step 92, the non-operating state of the autonomous machine 12 is determined based on a signal received by the first controller 30 from the sensing module 40 of the autonomous machine 12. The signal received by the first controller 30 from the sensing module 40 is indicative of one or more operating parameters of the autonomous machine 12. The operating parameters may include, but is not limited to, an engine speed, an engine temperature, a throttle position, ground speed, and an engine manifold pressure. Further, the system 90 initiates movement of the assisting machine 14 at the worksite 10, if the autonomous machine 12 is in the non-operating state.

The first controller 30 transmits data pertaining to the non-operating state of the autonomous machine 12 to the remote station 16. Based on the data received by the remote station 16 from the first controller 30, the remote station 16 transmits information to the second controller 52 of the assisting machine 14. The information transmitted by the remote station 16 to the second controller 52 pertains to a location of the autonomous machine 12 at the worksite 10. The second controller 52 drives the assisting machine 14 to the location of the autonomous machine 12, based on the information received from the remote station 16 pertaining to the location of the autonomous machine 12 at the worksite 10.

At step 94, the assisting machine 14 reaches the location of the autonomous machine 12 at the worksite 10. The second controller 52 of the assisting machine 14 initiates tilting of the bed 48 by the second controller 52, to deploy the wheel chock 58 on the ground surface 29. At step 96, the system 90 initiates the communication between the autonomous machine 12 and the wheel chock 58. The autonomous machine 12 transmits information regarding the one or more operating parameters of the autonomous machine 12 to the wheel chock 58.

The first controller 30 of the autonomous machine 12 communicates the one or more parameters of the autonomous machine 12 with the third controller 79 of the wheel chock 58. Similarly, the first controller 30 of the autonomous machine 12 also receives information regarding one or more parameters of the wheel chock 58. The one or more parameters of the wheel chock 58 may include, but are not limited to, a location of the wheel chock 58 with respect to the set of ground engaging members 28 of the autonomous machine 12.

When the wheel chock 58 receives information from the autonomous machine 12, at step 98, the wheel chock 58 moves towards the set of ground engaging members 28 of the autonomous machine 12. Particularly, the third controller 79 of the wheel chock 58 receives information from the first controller 30 of the autonomous machine 12. Based on information received from the first controller 30, the third controller 79 positions the wheel chock 58 adjacent with respect to the ground engaging member 28 of the autonomous machine 12. In an example, the third controller 79 may position the wheel chock 58 adjacent with respect to the ground engaging member 28 of the autonomous machine 12. In another example, multiple wheel chocks 58 may be positioned adjacent to the set of ground engaging members 28.

At step 99, the wheel chock 58 is moved away from the ground engaging member 28, if the autonomous machine 12 returns to an operating state. The operating state of the autonomous machine 12 is determined based on a signal received by the first controller 30 of the autonomous machine 12 from the sensing module 40 of the autonomous machine 12. The signal received by the first controller 30 from the sensing module 40 is indicative of the operating parameters of the autonomous machine 12. The first controller 30 transmits data pertaining to the operating state of the autonomous machine 12 to the remote station 16. Based on the data received by the remote station 16 from the first controller 30, the remote station 16 communicates to the second controller 52 of the assisting machine 14. The second controller 52 of the assisting machine 14 communicates with the third controller 79 of the wheel chock 58 such that wheel chock 58 may be recalled to the bed of the assisting machine 14.

### INDUSTRIAL APPLICABILITY

The present disclosure relates to the system 90 and a method 100 for operating the wheel chock 58 for assisting the autonomous machine 12 at the worksite 10. The method 100 is applicable to the wheel chock 58 and the autonomous machine 12 where autonomous operation is desired. The communication between the wheel chock 58 and the autonomous machine 12 facilitates autonomous operation of the wheel chock 58. The system 90 and the method 100 provide the wheel chock 58, which is directed by the first controller 30 of the autonomous machine 12, when the autonomous machine 12 is made to shutdown under abnormal operating conditions.

The system 90 and the method 100 offers a simple and easy method of autonomously operating the wheel chock 58 for assisting the autonomous machine 12 without the aid of a worker, who usually place a conventional wheel chock 58 against the ground engaging members 28 of the autonomous machine 12. The system 90 and the method 100 of the present disclosure eliminates disruption of work flow at the worksite 10. The disruption of workflow may be caused due to unnecessary movement of the worker to manually place the wheel chock 58, when the autonomous machine 12 is shutdown under abnormal conditions. Further, the system 90 and the method 100 eliminates risk associated with injury of the worker caused due to accidental movement of the autonomous machine 12 while manually placing the wheel chock 58.

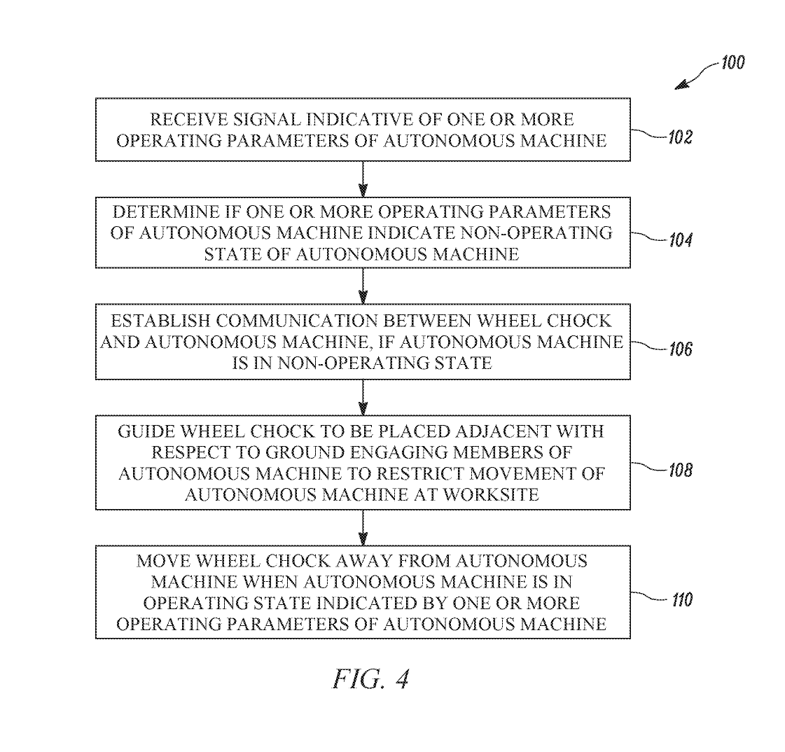

FIG. 4 illustrates a flowchart of the method 100 of operating the wheel chock 58 for assisting the autonomous machine 12 at the worksite 10. At step 102, the method 100 includes receiving the signal indicative of the one or more operating parameters of the autonomous machine 12. The one or more operating parameters of the autonomous machine 12 are detected by the sensing module 40 of the autonomous machine 12. The first controller 30 of the autonomous machine 12 transmits the signal indicative of the operating parameters of the autonomous machine 12 to the remote station 16 at the worksite 10.

At step 104, the method 100 includes determining if the operating parameters of the autonomous machine 12 indicate the non-operating state of the autonomous machine 12. At step 106, the method 100 includes establishing the communication between the wheel chock 58 and the autonomous machine 12, if the autonomous machine 12 is in the non-operating state. When the autonomous machine 12 is in the non operating state, the first controller 30 of the autonomous machine 12 communicates with the third controller 79 of the wheel chocks 58.

At step 108, the method 100 includes guiding the wheel chock 58 to be placed adjacent with respect to the ground engaging member 28 of the autonomous machine 12 to restrict movement of the autonomous machine 12 at the worksite 10, wherein the wheel chocks 58 is guided by the assisting machine 14. The third controller 79 of the wheel chock 58 receives instructions from the first controller 30 of the autonomous machine 12, to guide the wheel chocks 58 to be placed adjacent with respect to the set of ground engaging members 28 of the autonomous machine 12.

At step 110, the method 100 includes moving the wheel chock 58 away from the autonomous machine 12 when the autonomous machine 12 is in the operating state indicated by the one or more operating parameters of the autonomous machine 12. When the autonomous machine 12 returns to the operating state, the third controller 79 of the wheel chock 58 receives instructions from the first controller 30 of the autonomous machine 12, to guide the wheel chock 58 away from the set of ground engaging members 28 of the autonomous machine 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of operating a wheel chock for assisting an autonomous machine at a worksite, the method comprising:
receiving a signal indicative of one or more operating parameters of the autonomous machine;
determining if the one or more operating parameters of the autonomous machine indicate a non-operating state of the autonomous machine;
establishing a communication between the wheel chock and the autonomous machine, if the autonomous machine is in the non-operating state;
guiding the wheel chock to be placed adjacent with respect to ground engaging members of the autonomous machine to restrict movement of the autonomous machine at the worksite, wherein the wheel chock is guided by an assisting machine; and
moving the wheel chock away from the autonomous machine when the autonomous machine is in an operating state indicated by the one or more operating parameters of the autonomous machine.
